(19) United States
(12) Patent Application Publication
(10) Pub. No.: US 2019/0394507 A1
(43) Pub. Date: Dec. 26, 2019

(54) METHODS AND SYSTEMS FOR MANAGING VIEWER ENGAGEMENT OF LIVE STREAMING EVENTS

(71) Applicant: INTERNATIONAL BUSINESS MACHINES CORPORATION, Armonk, NY (US)

(72) Inventors: Christopher J. HARDEE, Raleigh, NC (US); Shikhar KWATRA, Morrisville, NC (US)

(73) Assignee: INTERNATIONAL BUSINESS MACHINES CORPORATION, Armonk, NY (US)

(21) Appl. No.: 16/013,629

(22) Filed: Jun. 20, 2018

(51) Int. Cl. H04N 21/24; H04N 21/2187; H04N 21/84; H04N 21/234; H04N 21/81

(52) U.S. Cl. CPC H04N 21/2407; H04N 21/2187; H04N 21/8133; H04N 21/23418; H04N 21/84

(57) ABSTRACT

Embodiments for managing viewer engagement of live streaming events by one or more processors are described. A plurality of viewer engagement components associated with a live streaming event are received. A grade for each of the plurality of viewer engagement components is determined based on information associated with the live streaming event. A rendering of at least some of the plurality of viewer engagement components by a computing node is caused to at least be delayed based on the determined grades.

### BACKGROUND OF THE INVENTION

### Field of the Invention

The present invention relates in general to computing systems, and more particularly, to various embodiments for managing viewer engagement of live streaming events.

### Description of the Related Art

“Live streaming” typically refers to real-time (or “live”) broadcasting of media (e.g., video, audio, etc.) via online (e.g., “Internet,” web, etc.) channels, often while the media is simultaneously being recorded. For example, a content creator (or presenter) may provide an live streaming video in which he/she discusses various topics such as politics, movies, products, religion, etc., which may be viewed (or accessed) by users (or viewers) through any suitable online channel, such as a websites or social media platforms.

During such live streaming events, viewers are often able to engage or interact with the content by, for example, posting comments, questions, and emoticons, which are often visible to the content creator and/or the other viewers via the online channel (e.g., in a pop-up window or a portion of the particular website that is dedicated to viewer engagement). Although it is often considered desirable for viewers to engage or interact with the live streaming event in this way, some of the comments posted may be irrelevant and distracting for the content creator and/or the other viewers, or may be redundant (e.g., multiple viewers may post the same question). This may particularly be a problem with a large number of viewers posting comments and/or when many comments are posted.

### SUMMARY OF THE INVENTION

Various embodiments for managing viewer engagement of live streaming events by one or more processors are described. In one embodiment, by way of example only, a method for managing viewer engagement of live streaming events, again by one or more processors, is provided. A plurality of viewer engagement components associated with a live streaming event are received. A grade for each of the plurality of viewer engagement components is determined based on information associated with the live streaming event. A rendering of at least some of the plurality of viewer engagement components by a computing node is caused to at least be delayed based on the determined grades.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a plan view of two windows including viewer engagement components received and rendered, respectively, during a live streaming event according to an embodiment of the present invention; and

FIG. 5 is a flowchart diagram of an exemplary method for managing viewer engagement of a live streaming event according to an embodiment of the present invention.

### DETAILED DESCRIPTION OF THE DRAWINGS

As discussed above, “live streaming” typically refers to real-time (or “live”) broadcast of media (e.g., video, audio, etc.) via online (e.g., “Internet,” web, etc.) channels, often while the media is simultaneously being recorded. For example, a content creator (or presenter) may provide a live streaming video in which he/she discusses various topics such as politics, movies, products, religion, etc., which may be viewed (or accessed) by users (or viewers) through any suitable online channel, such as a websites or social media platforms.

During such live streaming events, viewers are often able to engage or interact with the content by, for example, posting comments or questions, which are often visible to the content creator and/or the other viewers via the online channel (e.g., in a pop-up window or a portion of the particular website that is dedicated to viewer engagement). Although it is often considered desirable for viewers to engage or interact with the live streaming event in this way, some of the comments posted may be irrelevant and distracting for the content creator and/or the other viewers. For example, some comments may have little, or nothing, to do with the subject of the live stream (e.g., the live stream is a video presentation of a review of cooking products and some comments include political commentary). Also, some of the comments may be very similar (e.g., during a product review live stream, multiple viewers may post a question that asks how much the product costs). These issues may be particularly prevalent with a large number of viewers posting comments and/or when many comments are posted.

To address these needs, some embodiments described herein provide methods and systems for managing viewer engagement of live streaming events that allows for a reduction in the number of distracting, irrelevant, and/or redundant viewer engagement components (e.g., comments, questions, emoticons, etc.).

According to some embodiments described herein, a cognitive analysis or cognitive neural network system is used, which takes into account various types of information or data related to or associated with the live streaming event (or live stream), to modify the rendering or presentation of the viewer engagement components (e.g., comments) that are received during the live stream. The information may include, for example, input (and/or preferences) provided by the user (e.g., the streamer, content creator, or presenter), the content being streamed (e.g., the title and/or description of the live stream), the number of viewers, the amount of involvement/engagement of the viewers, the viewers' profiles, and dynamically learned preferences. The information may also include the content of the comments received. For example, the comments may be monitored for “blacklisted” or “whitelisted” terms or phrases, terms or phrases relevant to the content being streamed, repetitive comments, etc.

Based on the information, a grade (or score) may be determined (or calculated) for each of the received viewer engagement components. Using the determined grades, the viewer engagement components, or the presentation/rendering thereof, is modified or filtered. For example, the presentation/rendering of at least some of the viewer engagement components may be (intentionally) delayed such that the order in which the viewer engagement components are presented to the user (e.g., the presenter or a viewer of the live stream) is different from the order in which they are received (e.g., inputted/sent by the users/viewers), or some viewer engagement components may be completely prevented from being presented or rendered (e.g., blocked). For example, if multiple comments are determined to be similar (e.g., expressing generally the same sentiment or asking a similar question), a composite comment (or viewer engagement component), which may or may not be identical to one of the received comments, may be generated and presented in place of the multiple comments (at least before the individual comments are presented) in, for example, a single “thread.” Also, the presentation of the received comments may be prioritized based the relevance of the comments (e.g., with respect to the respective user/viewer).

The cognitive analysis may include classifying natural language, analyzing tone, and analyzing sentiment (e.g., scanning for keywords, key phrases, etc.) with respect to, for example, the received comments, information associated with viewers (e.g., in a user profile), and information related to the live stream (e.g., in a title, description, etc.). Over time, the methods and systems described herein may determine correlations (or insights) that allow for an improvement in the filtering of the viewer engagement components, perhaps with feedback provided by users, that allows for the performance of the system to improve with continued use.

As such, in some embodiments, the methods and/or systems described herein may utilize “machine learning,” “cognitive modeling,” “predictive analytics,” and/or “data analytics,” as is commonly understood by one skilled in the art. Generally, these processes may include, for example, receiving and/or retrieving multiple sets of inputs, and the associated outputs, of one or more systems and processing the data (e.g., using a computing system and/or processor) to generate or extract models, rules, etc. that correspond to, govern, and/or estimate the operation of the system(s), or with respect to the embodiments described herein, users' or viewers' engagement with live streaming events. Utilizing the models, the performance (or operation) of the system (e.g., utilizing/based on new inputs) may be predicted and/or the performance of the system may be optimized by investigating how changes in the input(s) effect the output(s).

In particular, in some embodiments, a method, by one or more processors, for managing viewer engagement of live streaming events is provided. A plurality of viewer engagement components associated with a live streaming event are received. A grade for each of the plurality of viewer engagement components is determined based on information associated with the live streaming event. A rendering of at least some of the plurality of viewer engagement components by a computing node is caused to at least be delayed based on the determined grades.

The determining of the grade for each of the plurality of viewer engagement components may include comparing each of the plurality of viewer engagement components to the others of the plurality of viewer engagement components. The causing of the rendering of at least some of the plurality of viewer engagement components by the computing node to at least be delayed may include generating a composite viewer engagement component. The composite viewer engagement component may be representative of the at least some of the plurality of viewer engagement components. The composite viewer engagement component may be caused to be rendered by the computing node.

Each of the plurality of viewer engagement components may include alphanumeric characters. The determining of the grade for each of the plurality of viewer engagement components may include searching each of the plurality of viewer engagement components for words on a predetermined list.

The information associated with the live streaming event may include at least one of information associated with an application utilized for the live streaming event, information associated with viewers of the live streaming event, or the number of viewer engagement components received. If the information associated with the live streaming event includes information associated with the viewers of the live streaming event, the information associated with the viewers of the live streaming event may include at least one of the number or viewers or an identity of each of the viewers.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment, such as cellular networks, now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

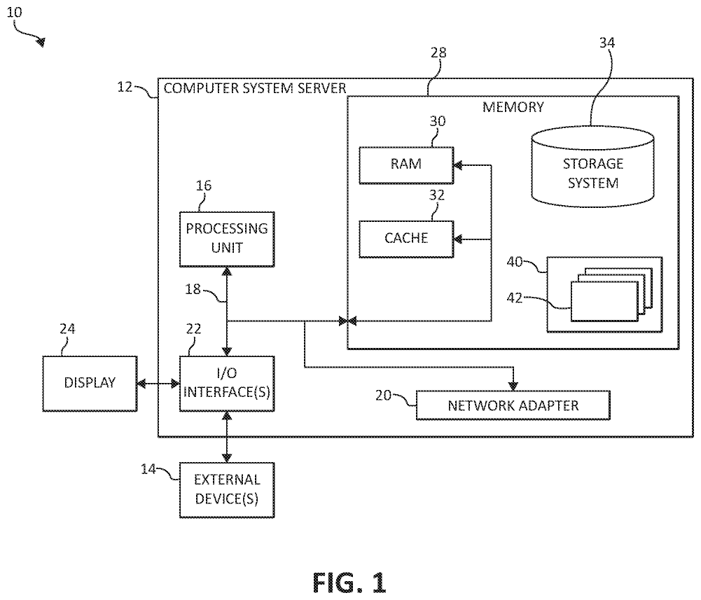

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 (and/or one or more processors described herein) is capable of being implemented and/or performing (or causing or enabling) any of the functionality set forth herein.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in, for example, personal computer systems, server computer systems, thin clients, thick clients, hand-held or laptop devices, multiprocessor systems, microprocessor-based systems, set top boxes, programmable consumer electronics, network PCs, mobile electronic devices such as mobile (or cellular and/or smart) phones, personal data assistants (PDAs), tablets, wearable technology devices, laptops, handheld game consoles, portable media players, etc., as well as computing systems in vehicles, such as automobiles, aircraft, watercrafts, etc. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

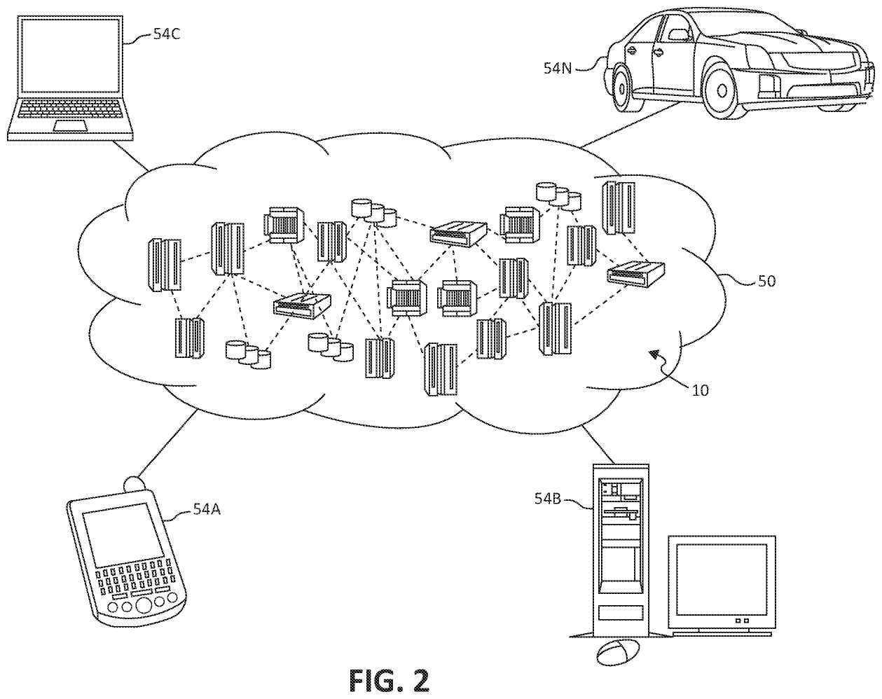

Referring now to FIG. 2, illustrative cloud computing environment 50 is depicted. As shown, cloud computing environment 50 comprises one or more cloud computing nodes 10 with which local computing devices used by cloud consumers, such as, for example, cellular telephone or PDA 54A, desktop computer 54B, and/or laptop computer 54C, and vehicles (e.g., automobiles, aircraft, watercraft, etc.) 54N may communicate.

Still referring to FIG. 2, nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

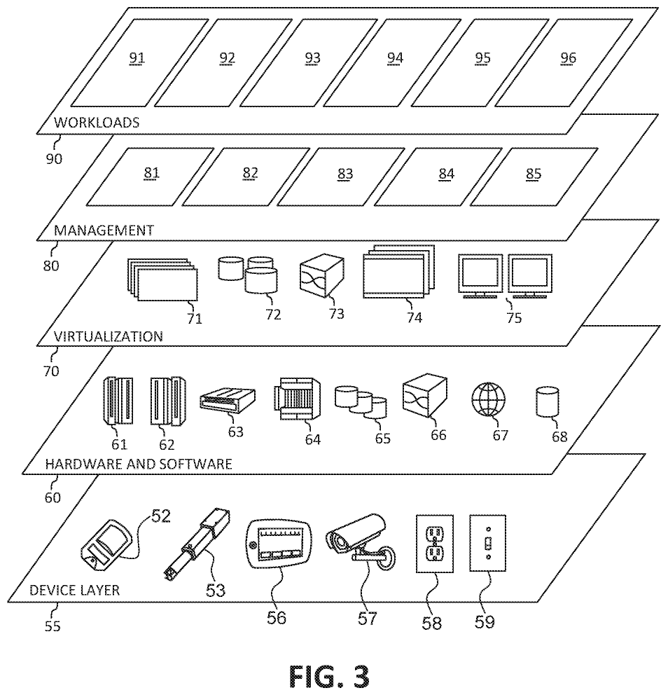

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to, various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for analyzing and managing viewer engagement of live streaming events as described herein. One of ordinary skill in the art will appreciate that the workloads and functions 96 may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As mentioned above, in some embodiments, viewer engagement of a live streaming event (or live stream) is managed (e.g., with respect to the manner in which it is rendered or presented) based on various types of information (or data) related to the live streaming event. The information may include, for example, input (and/or preferences) provided by the user (e.g., the streamer, content creator, or presenter), the content being streamed (e.g., the title and/or description of the live stream), the number of viewers, the amount of involvement/engagement of the viewers, the viewers' profiles, and dynamically learned preferences. The information may also include the content of received viewer engagement components, such as comments. For example, comments may be monitored for “blacklisted” or “whitelisted” terms or phrases, terms or phrases relevant to the content being streamed, repetitive comments, etc. A cognitive analysis may be performed on the information, and the viewer engagement components may be graded or scored. Based on the determined or calculated grades or scores, in some embodiments, the rendering of at least some of the viewer engagement components is at least delayed (e.g., delayed or blocked).

In some embodiments, the methods and systems described herein may be utilized by a user on any suitable computing node. As described herein, a computing node may refer to any computing device, such as those described above (e.g., desktop PC, mobile electronic device, etc.), and/or a software application installed on a computing device (e.g., a web browser or other application). The user may first provide various inputs that may be utilized, such as selecting a configuration and/or generating a user profile. The configuration may include any information or “options” related to the filtering, modifying, delaying, etc. of viewer engagement components, such as comments, received (or generated) during a live stream, as described below. It should be understood that the methods and system described herein may be utilized by any suitable user, including live stream presenters and viewers (i.e., individuals viewing the live stream presented by another user).

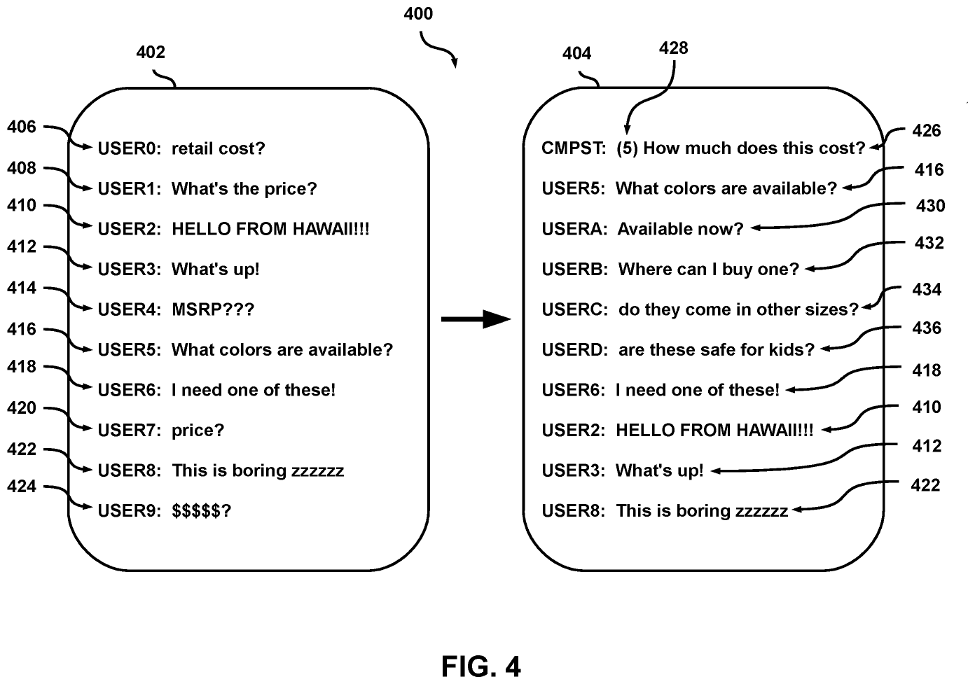

FIG. 4 illustrates a first “window” 402 and a second window 404 associated with the rendering of viewer engagement components during a live stream. It should be understood that windows 402 and 404 may be considered to represent display devices of computing devices, or portions of a display device of a computing device. However, windows 402 and 404 may also be considered to be provided simply to assist in understanding the methods and systems described herein (e.g., to illustrate the filtering, modifying, delaying, etc. of viewer engagement components described herein). As described in greater detail below, in the embodiment shown, window 402 may be understood to show (or include) a list of viewer engagement components as received during a live stream (e.g., as created/sent by viewers), while window 404 may be understood to show a (modified or filtered) list of viewer engagement components as they are rendered and/or presented to the user.

Still referring to FIG. 4, in window 402, viewer engagement components (i.e., comments) 406-424 are shown, each of which has been received from (or generated by) a unique user (or viewer) (i.e., USER0-USER9). In the particular example shown in FIG. 4, it should be understood that the comments 406-424 are those received (or generated by viewers) during a live stream related to a product demonstration and/or review. The order in which the comments 406-424 may be indicative of the order in which the comments 406-424 are received (or generated) with, for example, the first/earliest comments being shown at the top of the list (e.g., comment 406 was received first, and comment 424 was received last). As will be described in greater detail below, the comments 406-424 may be only a portion of the viewer engagement components received during the live stream.

In at least some embodiments, the comments 406-424 (as well as another other viewer engagement components received during the live stream) are graded or scored using, for example, a cognitive analysis utilizing various types of information related to the live stream, including perhaps the content of the comments 406-424 themselves. The cognitive analysis may include classifying natural language, analyzing tone, and analyzing sentiment (e.g., scanning for keywords, key phrases, etc.) of information related to the live stream and the content of the viewer engagement components, as well as comparing the received viewer engagement components to each other. In some embodiments, the grades determined (or calculated) for the comments 406-424 are numerical (e.g., scores) and may be based on any suitable scale (e.g., positive or negative integers). However, the grades may also essentially be a categorization of the comments into different groups, such as “high priority” or “high relevance,” “low priority” or “low relevance,” etc.

The information utilized may include information related to an application being utilized during the live stream (e.g., the name/title of a game, identification “tags” added by the presenter, the title of the live stream, etc.). The number of viewers watching the live stream may also be utilized, as well as information related to the viewers (e.g., identity, social media activity, membership in groups/organizations, etc.) and the amount of viewer engagement being received (e.g., the number of comments being posted by viewers).

As described above, the content of the comments 406-424 may also be used. For example, a “blacklists” and/or “whitelists” (e.g., created by the presenter, another user, or administrator) may be used to determine the grades of the comments 406-424. With respect to blacklists, if words/phrases on the list are found in the comments, such comments may be determined to have a relatively low grade (or the presence of the blacklisted words/phrases may at least adversely affect the grade of those comments). Likewise, with respect to whitelists, if words/phrases on the list are found in the comments, such comments may be determined to have a relatively high grade and/or be relatively relevant to the live stream (or the presence of the whitelisted words/phrases may at least positively affect the grade of those comments). Also, the cognitive analysis may be used to analyze the natural language, tone, sentiment, etc. of the comments for relevance to the live stream (e.g., based on the title and/or description of the live stream) and/or similarities between comments (or other viewer engagement components) from the same user/viewer or multiple viewers.

After the comments 406-424 are graded (or scored), the grades may be used to filter, modify, and/or delay at least some of the comments 406-424, or at least the rendering or presentation thereof. Still referring to FIG. 4, in window 404 the comments shown are ordered as 426, 416, 430, 432, 434, 436, 418, 410, 412, and 422, which in a manner similar to window 402, may be indicative of the order in which the comments are rendered or presented (e.g., comment 426 is rendered first, and comment 422 is rendered last).

In the example shown, comment 426 is a “composite” comment that has been generated (and rendered) to represent several of the received comments shown in window 402. In particular, in window 402, comments 406, 408, 414, 420, and 424 may be determined to be similar (and/or assigned the same grade), as each of those comments are related to the price or cost of the product that is the subject of the live stream. As such, the composite comment 426 has been generated to pose the same question as comments 406, 408, 414, 420, and 424 (e.g., “How much does this cost?”). In other embodiments, the composite comment 426 may be identical to, or at least include, one of the received comments (e.g., comment 408, “What's the price?”). In the example shown, composite comment 426 is provided with a “user name” that is indicative that it is a composite comment (e.g., CMPST) and also includes a “counter” element 428 (e.g., (5)) that indicates the number of comments that were “combined,” “bundled,” or “collapsed” into composite comment 426 (e.g., five comments, 406, 408, 414, 420, and 424, were combined into composite comment 426).

As such, in some embodiments, composite viewer engagement components are rendered in a way that indicates that they have been generated based on several individual comments. Other manners (besides the user name) in which such could be indicated may include highlighting the composite viewer engagement component and/or rendering the characters thereof in colors different than that of other viewer engagement components. Other manners (besides the counter element 428) in which the number of viewer engagement components combined is indicated may include rendering the characters thereof (e.g., text characters, “emoticons,” or other symbols such as “thumbs up”) in different sizes (e.g., larger font than that of the other viewer engagement components) and/or colors (e.g., red text indicating a “hot” comment made by multiple viewers, orange text indicating a comment made by less viewers than red text, etc.)

It should also be noted that comments 406, 408, 414, 420, and 424 are not shown in window 404. That is, the rendering (or presentation) of comments 406, 408, 414, 420, and 424 has at least been delayed (e.g., in lieu of the rendering of composite comment 426). In some embodiments, viewer engagement components that are at least initially delayed may be rendered at a later time. For example, if during the live stream, there is a time period with a reduced number of viewer engagement components received (i.e., there is a “lull” in viewer engagement), the delayed viewer engagement comments may be rendered at that time (or completed deleted/never rendered). As another example, a “report” may be provided to the presenter (or other user), such as through the same application used to render the viewer engagement components during the live stream or via an electronic message (e.g., email), after the live stream, indicating or showing the received viewer engagement components that were not considered sufficiently relevant (e.g., did not receive a sufficiently high grade or score) to be rendered during the live steam. Further, viewers who provide or generate viewer engagement components may be provided with information regarding how their comments, actions, or emoticons appear to the streamer or other viewers.

Still referring to FIG. 4, the other comments, 416, 430, 432, 434, 436, 418, 410, 412, and 422, in window 404 may be rendered or presented in order based on the determined grades thereof, which may result in the comments being shown in an order different than that in which they were received. For example, it should be noted that comment 416 is rendered before comments 410 and 412 even though comments 410 and 412 were received before comment 416, as indicated in window 402. It should also be noted that comments 430, 432, 434, and 436 are rendered before comments 410, 412, 418, and 422 even though comments 430-436 are not shown in window 402 (e.g., comments 430-436 were received after comment 424). That is, in the illustrated example, comments 430-436 are rendered before comments 410, 412, 418, and 422 because of the determined grades of the comments (e.g., comments 430-436 have been determined to be more relevant to the live stream than comments 410, 412, 418, and 422). As such, the rendering of comments 410, 412, 418, and 422 has been delayed until after the rendering of comments 430-436.

In some embodiments, after a user's (e.g., a presenter's or viewer's) configuration or preferences are set, the same configuration may be used the next time the user encounters a similar situation. The content detection is done and can be fed in the unsupervised machine learning model to cluster the data. As such, after the grading of the received viewer engagement components is performed, the data is simply differentiated and categorized in order of relevance to prioritize or display the most relevant viewer engagement components to the user, thereby encapsulating the irrelevant comments or distractions. The configuration may be saved each time based on the different configuration settings, and the system may use this as a form of implicit/explicit feedback from the user as a measure or means of storing the user's present and future preferences.

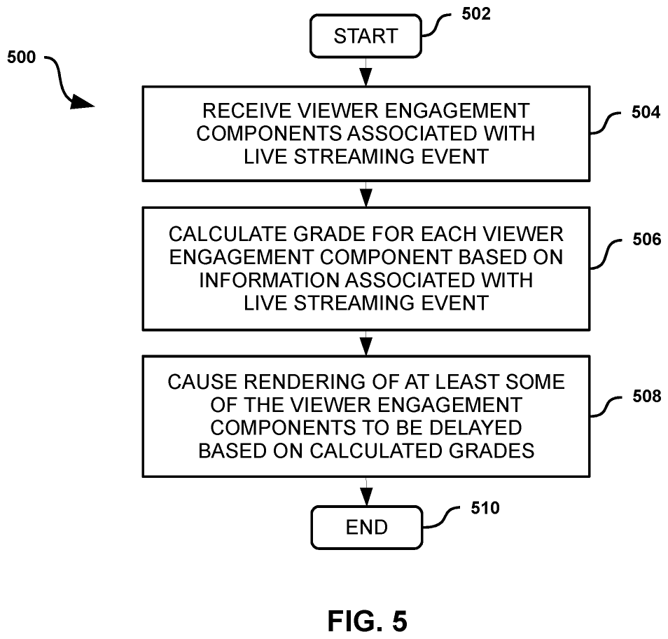

Turning to FIG. 5, a flowchart diagram of an exemplary method 500 for managing viewer engagement of live streaming events is illustrated. Method 500 begins (step 502) with, for example, a user (e.g., a presenter of a live stream or viewer of a live stream) providing various inputs (or a configuration) that may be utilized for filtering, modifying, and/or delaying the rendering of viewer engagement components, such as comments, received or generated during a live streaming event, as described above and/or the live streaming event being initiated.

A plurality of viewer engagement components associated with the live streaming event are received (step 504). Each of the plurality of viewer engagement components may include alphanumeric characters (e.g., text comments), emoticons, or other symbols (e.g., “thumbs up.).

A grade for each of the plurality of viewer engagement components is determined (or calculated) based on information associated with the live streaming event (step 506). The information associated with the live streaming event may include at least one of information associated with an application utilized for the live streaming event, information associated with viewers of the live streaming event, or the number of viewer engagement components received. If the information associated with the live streaming event includes information associated with the viewers of the live streaming event, the information associated with the viewers of the live streaming event may include at least one of the number or viewers or an identity of each of the viewers. The determining of the grade for each of the plurality of viewer engagement components may include, for example, comparing each of the plurality of viewer engagement components to the others of the plurality of viewer engagement components and/or searching each of the plurality of viewer engagement components for words on a predetermined list.

A rendering of at least some of the plurality of viewer engagement components by a computing node is caused to at least be delayed based on the determined grades (508). The causing of the rendering of at least some of the plurality of viewer engagement components by the computing node to at least be delayed may include generating a composite viewer engagement component. The composite viewer engagement component may be representative of the at least some of the plurality of viewer engagement components. The composite viewer engagement component may be caused to be rendered by the computing node.

Method 500 ends (step 510) with, for example, the viewer engagement components that were delayed being rendered or presented to the appropriate user. For example, a report may be provided to the user (e.g., via an electronic message, such as an email, or in the same window used to render viewer engagement components during the live stream) after the live streaming event ends. The user's configuration may be utilized in later cycles (e.g., subsequent live streaming events) to filter, modify, and/or delay received viewer engagement components in a similar manner.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method, by one or more processors, for managing viewer engagement of live streaming events comprising:
receiving a plurality of viewer engagement components associated with a live streaming event;
determining a grade for each of the plurality of viewer engagement components based on information associated with the live streaming event; and
causing a rendering of at least some of the plurality of viewer engagement components by a computing node to at least be delayed based on the determined grades.

2. The method of claim 1, wherein the determining of the grade for each of the plurality of viewer engagement components includes comparing each of the plurality of viewer engagement components to the others of the plurality of viewer engagement components.

3. The method of claim 2, wherein the causing of the rendering of at least some of the plurality of viewer engagement components by the computing node to at least be delayed includes generating a composite viewer engagement component, the composite viewer engagement component being representative of the at least some of the plurality of viewer engagement components, and further comprising causing the composite viewer engagement component to be rendered by the computing node.

4. The method of claim 1, wherein each of the plurality of viewer engagement components includes alphanumeric characters.

5. The method of claim 4, wherein the determining of the grade for each of the plurality of viewer engagement components includes searching each of the plurality of viewer engagement components for words on a predetermined list.

6. The method of claim 1, wherein the information associated with the live streaming event includes at least one of information associated with an application utilized for the live streaming event, information associated with viewers of the live streaming event, or the number of viewer engagement components received.

7. The method of claim 6, wherein the information associated with the live streaming event includes information associated with the viewers of the live streaming event, and wherein the information associated with the viewers of the live streaming event includes at least one of the number or viewers or an identity of each of the viewers.

8. A system for managing viewer engagement of live streaming events comprising:
at least one processor that
receives a plurality of viewer engagement components associated with a live streaming event;
determines a grade for each of the plurality of viewer engagement components based on information associated with the live streaming event; and
causes a rendering of at least some of the plurality of viewer engagement components by a computing node to at least be delayed based on the determined grades.

9. The system of claim 8, wherein the determining of the grade for each of the plurality of viewer engagement components includes comparing each of the plurality of viewer engagement components to the others of the plurality of viewer engagement components.

10. The system of claim 9, wherein the causing of the rendering of at least some of the plurality of viewer engagement components by the computing node to at least be delayed includes generating a composite viewer engagement component, the composite viewer engagement component being representative of the at least some of the plurality of viewer engagement components, and wherein the at least one processor further causes the composite viewer engagement component to be rendered by the computing node.

11. The system of claim 8, wherein each of the plurality of viewer engagement components includes alphanumeric characters.

12. The system of claim 11, wherein the determining of the grade for each of the plurality of viewer engagement components includes searching each of the plurality of viewer engagement components for words on a predetermined list.

13. The system of claim 8, wherein the information associated with the live streaming event includes at least one of information associated with an application utilized for the live streaming event, information associated with viewers of the live streaming event, or the number of viewer engagement components received.

14. The system of claim 13, wherein the information associated with the live streaming event includes information associated with the viewers of the live streaming event, and wherein the information associated with the viewers of the live streaming event includes at least one of the number or viewers or an identity of each of the viewers.

15. A computer program product for managing viewer engagement of live streaming events by one or more processors, the computer program product comprising a non-transitory computer-readable storage medium having computer-readable program code portions stored therein, the computer-readable program code portions comprising:
an executable portion that receives a plurality of viewer engagement components associated with a live streaming event;
an executable portion that determines a grade for each of the plurality of viewer engagement components based on information associated with the live streaming event; and
an executable portion that causes a rendering of at least some of the plurality of viewer engagement components by a computing node to at least be delayed based on the determined grades.

16. The computer program product of claim 15, wherein the determining of the grade for each of the plurality of viewer engagement components includes comparing each of the plurality of viewer engagement components to the others of the plurality of viewer engagement components.

17. The computer program product of claim 16, wherein the causing of the rendering of at least some of the plurality of viewer engagement components by the computing node to at least be delayed includes generating a composite viewer engagement component, the composite viewer engagement component being representative of the at least some of the plurality of viewer engagement components, and wherein the computer-readable program code portion further include an executable portion that causes the composite viewer engagement component to be rendered by the computing node.

18. The computer program product of claim 15, wherein each of the plurality of viewer engagement components includes alphanumeric characters.

19. The computer program product of claim 18, wherein the determining of the grade for each of the plurality of viewer engagement components includes searching each of the plurality of viewer engagement components for words on a predetermined list.

20. The computer program product of claim 15, wherein the information associated with the live streaming event includes at least one of information associated with an application utilized for the live streaming event, information associated with viewers of the live streaming event, or the number of viewer engagement components received.

21. The computer program product of claim 20, wherein the information associated with the live streaming event includes information associated with the viewers of the live streaming event, and wherein the information associated with the viewers of the live streaming event includes at least one of the number or viewers or an identity of each of the viewers.
